(19) United States
(12) Patent Application Publication
(10) Pub. No.: US 2009/0091236 A1
(43) Pub. Date: Apr. 9, 2009

(54) Plasma display panel having alignment structures and method of fabricating the same

(76) Inventors: Yu-Jeong Cho, Suwon-si (KR); Sang-Hyuck Ahn, Suwon-si (KR); Kyoung-Doo Kang, Suwon-si (KR); Won-Ju Yi, Suwon-si (KR)

Correspondence Address: LEE & MORSE, P.C., 3141 FAIRVIEW PARK DRIVE, SUITE 500, FALLS CHURCH, VA, 22042, US

(21) Appl. No.: 12/285,340

(22) Filed: Oct. 2, 2008

(30) Foreign Application Priority Data
Oct. 4, 2007 (KR) 10-2007-0099875

(51) Int. Cl. H01J 63/04; H01J 9/24

(52) U.S. Cl. 313/493; 445/24

(57) ABSTRACT

A display panel includes a first substrate and a second substrate, the first and second substrates having inner surfaces facing each other, a plurality of electrodes disposed between the first substrate and the second substrate, a partitioning green sheet disposed between the first substrate and the second substrate, and a plurality of alignment structures on an inner surface of at least one of the first and second substrates, the alignment structures providing an alignment reference for aligning the partitioning green sheet with the inner surface, wherein at least one of the alignment structures contacts an edge of the partitioning green sheet.

### BACKGROUND OF THE INVENTION

1. Field of the Invention

Embodiments relate to a plasma display panel having alignment structures and method of fabricating the same.

2. Description of the Related Art

A plasma display panel (PDP) may include a plurality of functional layers between opposing substrates. During fabrication, it may be important to prevent the functional layers from being contaminated. Thus, an intermediate layer, such as a green sheet, may be disposed between the substrates, with green sheets referring to at least one of the aforementioned functional layers formed into sheets and interposed between substrates. When the substrates are sealed by applying a sealing agent along edges of the substrates between which the green sheet is interposed, if the green sheet and the sealing agent contact each other, the substrates may not be well sealed and there is a risk of the substrates cracking. Accordingly, there is a need to align the green sheet between the substrates within a range of the process margin of the panel assembly.

### SUMMARY OF THE INVENTION

Embodiments are therefore directed to a PDP having alignment structures and method of fabricating the same, which substantially overcome one or more of the problems due to the limitations and disadvantages of the related art.

It is therefore a feature of an embodiment to provide a PDP having alignment structures for aligning an intermediate substrate by positively engaging with the alignment structures, and a method of fabricating the same.

At least one of the above and other features and advantages may be realized by providing a display panel, including a first substrate and a second substrate, the first and second substrates having inner surfaces facing each other, a plurality of electrodes disposed between the first substrate and the second substrate, a partitioning green sheet disposed between the first substrate and the second substrate, and a plurality of alignment structures on an inner surface of at least one of the first and second substrates, the alignment structures providing an alignment reference for aligning the partitioning green sheet with the inner surface, wherein at least one of the alignment structures contacts an edge of the partitioning green sheet.

The alignment structures may contact corners, shorter sides, and/or longer sides of the partitioning green sheet. Each of the first substrate and the second substrate may include a display region displaying an image and a non-display region outside the display region, and the alignment structures may be formed in the non-display region.

The alignment structures may project from the inner surface, and the alignment structures may have a height greater than that of the electrodes. The alignment structures may have a height equal to a distance between the first substrate and the second substrate, and the alignment structures may contact the first substrate and the second substrate. The alignment structures may have a maximum height less than a distance between the first substrate and the second substrate.

The alignment structures may include an insulating material. The electrodes may include first electrodes disposed in a first direction on the inner surface of the first substrate and second electrodes disposed in a second direction crossing the first direction on the inner surface of the second substrate, and the partitioning green sheet may be disposed between the first electrodes and the second electrodes. The electrodes may include a metal foil. A dielectric layer may cover a surface of the metal foil, and the dielectric layer may include an oxide of a metal included in the metal foil. A protective layer may be on a surface of the dielectric layer. The alignment structures may include a same material as one or more of the electrodes, the dielectric layer, and the protective layer.

The alignment structures may have a bent shape, a bar shape, a curved shape, and/or a dot shape. The partitioning green sheet may be disposed between a plurality of first electrodes and a plurality of second electrodes, and the partitioning green sheet may include openings corresponding to discharge spaces. The openings in the partitioning green sheet may have tapered sidewalls, such that a cross-sectional area in a plane parallel to the first and second substrates decreases along an axis perpendicular to a major surface of the first and second substrates. The openings in the partitioning green sheet may become narrower towards the second substrate, electrodes on the second substrate may have openings corresponding to the openings in the partitioning green sheet, and the openings in the partitioning sheet and the openings in the electrodes on the second substrate may have a same size at an interface thereof. Phosphor layers may be on the sidewalls of the openings in the partitioning green sheet.

At least one of the above and other features and advantages may also be realized by providing a method of manufacturing a display panel, including arranging a first substrate and a second substrate such that inner surfaces of the first and second substrates face each other, forming a plurality of electrodes between the first substrate and the second substrate, forming a plurality of alignment structures on an inner surface of at least one of the first and second substrates, the alignment structures providing an alignment reference for aligning a partitioning green sheet with the inner surface, and aligning the partitioning green sheet between the first substrate and the second substrate, wherein at least one of the alignment structures contacts an edge of the partitioning green sheet.

Forming the alignment structures may include forming the alignment structures to have a height greater than that of the electrodes. Aligning the partitioning green sheet may include positioning the partitioning green sheet so that the alignment structures contact corners, shorter sides, and/or longer sides of the partitioning green sheet.

### BRIEF DESCRIPTION OF THE DRAWINGS

The above and other features and advantages will become more apparent to those of ordinary skill in the art by describing in detail example embodiments thereof with reference to the attached drawings, in which:

FIG. 1 illustrates an exploded perspective view of a PDP according to an embodiment;

FIG. 2 illustrates an enlarged cross-sectional view taken along line II-II of FIG. 1;

FIG. 3 illustrates a plan view of electrodes and alignment structures in an X-Y plane of FIG. 1;

FIG. 4 illustrates a plan view of the alignment structures and a partitioning green sheet in the X-Y plane of FIG. 3;

FIG. 5 illustrates an enlarged perspective view of an alignment structure and the partitioning green sheet shown in FIG. 4; and

FIGS. 6-8 illustrate plan views in the X-Y plane of FIG. 1 showing stages in a method of fabricating a PDP according to an embodiment.

### DETAILED DESCRIPTION OF THE INVENTION

Korean Patent Application No. 10-2007-0099875, filed on Oct. 4, 2007, in the Korean Intellectual Property Office, and entitled: “Plasma Display Panel Having Improved Alignment structure and Method of Fabricating the Plasma Display Panel,” is incorporated by reference herein in its entirety.

Example embodiments will now be described more fully hereinafter with reference to the accompanying drawings; however, they may be embodied in different forms and should not be construed as limited to the embodiments set forth herein. Rather, these embodiments are provided so that this disclosure will be thorough and complete, and will fully convey the scope of the invention to those skilled in the art.

In the drawing figures, the dimensions of layers and regions may be exaggerated for clarity of illustration. It will also be understood that when a layer or element is referred to as being “on” another layer or substrate, it can be directly on the other layer or substrate, or intervening layers may also be present. Further, it will be understood that when a layer is referred to as being “under” another layer, it can be directly under, and one or more intervening layers may also be present. In addition, it will also be understood that when a layer is referred to as being “between” two layers, it can be the only layer between the two layers, or one or more intervening layers may also be present. Like reference numerals refer to like elements throughout.

As used herein, the expressions “at least one,” “one or more,” and “and/or” are open-ended expressions that are both conjunctive and disjunctive in operation. For example, each of the expressions “at least one of A, B, and C,” “at least one of A, B, or C,” “one or more of A, B, and C,” “one or more of A, B, or C” and “A, B, and/or C” includes the following meanings: A alone; B alone; C alone; both A and B together; both A and C together; both B and C together; and all three of A, B, and C together. Further, these expressions are open-ended, unless expressly designated to the contrary by their combination with the term “consisting of.” For example, the expression “at least one of A, B, and C” may also include an nth member, where n is greater than 3, whereas the expression “at least one selected from the group consisting of A, B, and C” does not.

As used herein, the expression “or” is not an “exclusive or” unless it is used in conjunction with the term “either.” For example, the expression “A, B, or C” includes A alone; B alone; C alone; both A and B together; both A and C together; both B and C together; and all three of A, B and, C together, whereas the expression “either A, B, or C” means one of A alone, B alone, and C alone, and does not mean any of both A and B together; both A and C together; both B and C together; and all three of A, B and C together.

As used herein, the terms “a” and “an” are open terms that may be used in conjunction with singular items or with plural items. For example, the term “a phosphor” may represent a single compound or multiple compounds in combination. It will also be understood that the term “phosphor” is intended to generally refer to a material that can generate visible light upon excitation by photons or electrons that impinge thereon, and is not intended be limited to materials the undergo light emission through any particular mechanism or over any particular time frame.

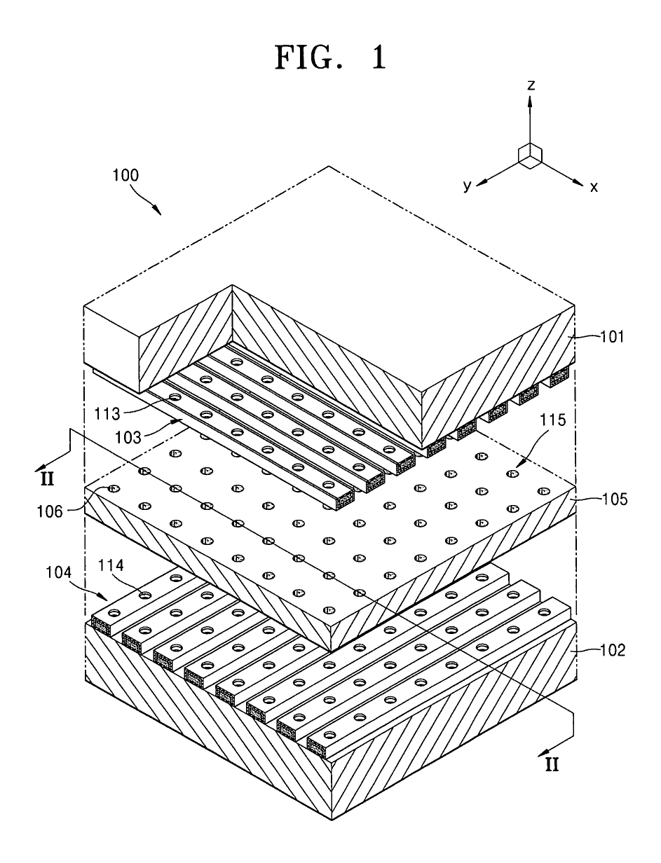

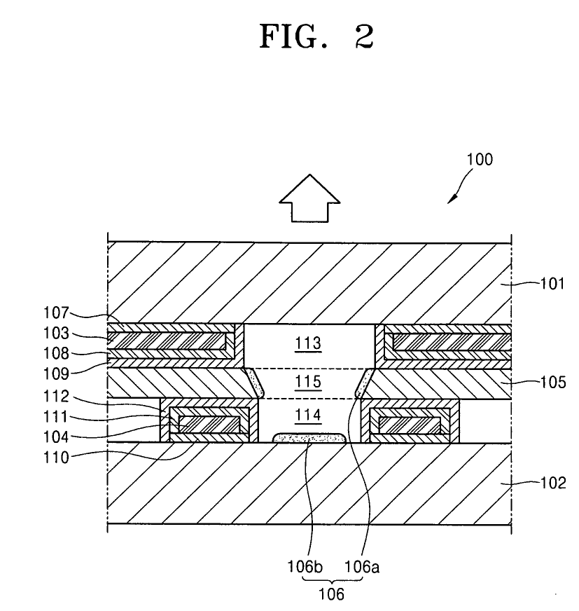

FIG. 1 illustrates an exploded perspective view of a PDP 100 according to an embodiment, and FIG. 2 illustrates an enlarged cross-sectional view taken along line II-II of FIG. 1. Referring to FIGS. 1 and 2, the PDP 100 may include a first substrate 101 and a second substrate 102 parallel to the first substrate 101. The first substrate 101 and the second substrate 102 may be sealed together using frit glass (not shown) applied along edges of inner surfaces of the first substrate 101 and second substrate 102. The first substrate 101 and the second substrate may have inner surfaces facing each other, and may be sealed together to form a sealed discharge space. Each of the first substrate 101 and the second substrate 102 may be a transparent substrate, such as a soda lime glass substrate, or a semi-transmissive substrate, a reflective substrate, a colored substrate, etc.

First discharge electrodes 103 may be disposed on the inner surface of the first substrate 101. The first discharge electrodes 103 may extend in a first direction, e.g., the X direction in FIG. 1, and may be separated by predetermined intervals in a second direction, e.g., the Y direction in FIG. 1. Second discharge electrodes 104 may be disposed on the inner surface of the second substrate 102. The second discharge electrodes 104 may extend in the Y direction so as to cross the first discharge electrodes 101, and may be separated by predetermined intervals in the X direction. The first discharge electrodes 103 and the second discharge electrodes 104 may be a patterned metal foil.

A partitioning green sheet 105 may be disposed between the first substrate 101 and the second substrate 102 to define discharge cells therebetween and to prevent crosstalk between adjacent discharge cells. The partitioning green sheet 105 may be between the first electrodes 103 and the second electrodes 104. A discharge gas, such as a gas mixture of neon and xenon (Ne—Xe) or helium and xenon (He—Xe), may be injected into the sealed discharge space between the first substrate 101 and the second substrate 102, and may fill the discharge spaces defined by the partitioning green sheet 105. Phosphor layers. 106, e.g., different phosphors respectively emitting different colors of light, may be formed on inner surfaces of the discharge cells, and may be excited by ultraviolet rays generated from the discharge gas to emit visible light. The phosphor layers 106 may be disposed in open holes 115 in the partitioning green sheet 105.

The first discharge electrodes 103 may be formed on the inner surface of the first substrate 101, and may be formed of, e.g., a metal foil such as an aluminum foil. In another implementation, the first discharge electrodes 103 may be formed of a metallic material having high conductivity such as silver (Ag) paste. The metal foil may have a thickness of several micrometers to tens of micrometers. The first discharge electrodes 103 may be formed by patterning the metal foil to form electrodes. The first discharge electrodes 103 may extend in the X direction of the PDP 100. The intervals between adjacent first electrodes 103 may be determined by etching the metal foil during formation of the first electrodes 103.

In an implementation, a first adhering green sheet 107 may be interposed between the first discharge electrodes 103 and the first substrate 101, and may serve to firmly adhere the first discharge electrodes 103 to the first substrate 101. For example, by interposing the first adhering green sheet 107 between the first discharge electrodes 103 and the first substrate 101, the first discharge electrodes 103 may be firmly adhered to the first substrate 101 using a firing process. The firing process may be performed at a temperature higher than a temperature at which the first adhering green sheet 107 melts.

The first discharge electrodes 103 and the first adhering green sheet 107 interposed under the first discharge electrodes 103 may be etched to form first open holes 113 each having a predetermined diameter. The first open holes 113 may be spaced at predetermined intervals in the X direction of the PDP 100.

A first dielectric layer 108 may be formed on surfaces of the first discharge electrodes 103. The first dielectric layer 108 may be, e.g., a metal oxide layer formed by oxidizing the surfaces of the first discharge electrodes 103 using an electrochemical treatment such as anodizing. In another implementation, the first dielectric layer 108 may be formed by covering the first discharge electrodes 103 with a dielectric material. The first dielectric layer 108 may completely cover the surfaces of the first discharge electrodes 103.

A first protective layer 109, such as a MgO layer, may be formed on a surface of the first dielectric layer 108, and may extend along edges of the first adhering green sheet 107. The first protective layer 109 may prevent damage to the surface of the dielectric layer 108 and may accumulate wall charges during operation of the PDP.

The second discharge electrodes 104 may extend in the Y direction on the inner surface of the second substrate 102, and may cross the X direction in which the first discharge electrodes 103 extend. The second discharge electrodes 104 may be formed of a metal foil, e.g. an aluminum foil, a metallic material having high conductivity, such as silver (Ag) paste, etc.

A second adhering green sheet 10O formed of a dielectric material may be interposed between the second substrate 102 and the second discharge electrodes 104. The second adhering green sheet 110 may serve to firmly adhere the second discharge electrodes 104 to the second substrate 102. The second discharge electrodes 104 and the second adhering green sheet 110 stacked on the second discharge electrodes 104 may be etched to form second open holes 114. The second open holes 114 may each have a predetermined diameter and may be spaced at predetermined intervals in the Y direction of the PDP 100. A second dielectric layer 111 may be formed on surfaces of the second discharge electrodes 104, e.g., by anodizing. A second protective layer 112 may be formed on an outer surface of the first dielectric layer 111, may completely cover the first dielectric layer 111, and may extend along edges of the second adhering green sheet 110.

The partitioning green sheet 105 may be disposed between the first substrate 101 and the second substrate 102, e.g., between the first discharge electrodes 103 and the second discharge electrodes 104. The partitioning green sheet 105 may be formed of a high dielectric material, e.g., a material having a component such as ZnO—B₂O₃—Bi₂O₃, PbO—B₂O₃—SiO₂, PbO, or Bi₂O₃, as a main component. The high dielectric material may prevent direct electrical conduction between the first discharge electrodes 103 and the second discharge electrodes 104, may prevent cations or electrons from damaging the first discharge electrodes 103 and the second discharge electrodes 104, and may generate charges and accumulate wall charges during operation of the PDP.

The partitioning green sheet 105 may include third open holes 115 formed at points where the first discharge electrodes 103 and the second discharge electrodes 104 cross each other. The first open holes 113, the second open holes 114, and the third open holes 115 may be aligned and may communicate with one another to form a single discharge space. The discharge space may have a circular shape in plan view, i.e., in the X-Y plane in FIG. 1, or may have a shape such as a polygonal shape (e.g., a square shape or a hexagonal shape), an oval shape, or any shape suitable to divide the discharge space into a plurality of discharge cells.

The phosphor layers 106 may include first phosphor layers 106a on sidewalls of the third open holes 115 of the partitioning green sheet 105. The phosphor layers 106 may also include second phosphor layers 106b on portions of the inner surface of the second substrate 102 exposed by the second open holes 114. The phosphor layers 106 may include red, green, and blue phosphor layers respectively distributed in the discharge spaces according to red, green, and blue subpixels. The red phosphor layers may include, e.g., (Y,Gd)BO₃;Eu⁺³, the green phosphor layers may include, e.g., Zn₂SiO₄:Mn²⁺, and the blue phosphor layers may include, e.g., BaMgAl₁₀O₁₇:Eu²⁺. The first phosphor layers 106a and the second phosphor layers 106b may have the same color. In an implementation, white phosphor layers may be added to the red, green, and blue phosphor layers 106 to increase the color gamut between color coordinates.

During formation of the first phosphor layers 106a on portions of the inner walls of the discharge cells of the partitioning green sheet 105 contacting the third open holes 115, the third open holes 115 may be aligned with and communicate with the first open holes 113 and the second open holes 114. The partitioning green sheet 105 may be aligned with the first substrate 101 and/or the second substrate 102 using one or more alignment structures 301, described in detail below, installed along edges of the first substrate 101 and/or the second substrate 102.

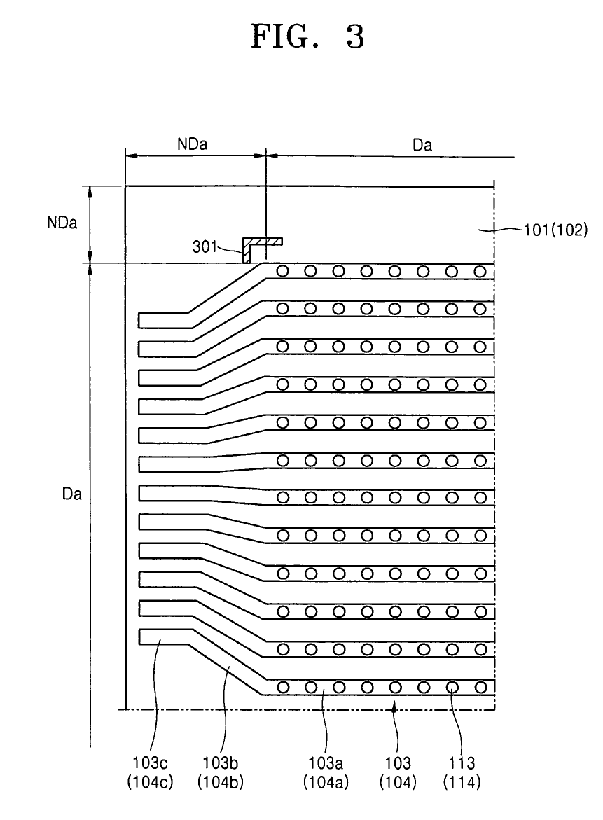

FIG. 3 illustrates a plan view of electrodes and alignment structures in an X-Y plane of FIG. 1. In particular, FIG. 3 illustrates alignment structures 301 formed on the first substrate 101. In FIG. 3 and the description thereof, parenthetical references indicate features in an embodiment wherein the alignment structures 301 are on the second substrate 102 of the PDP 100 illustrated in FIG. 1.

Referring to FIG. 3, each of the first and second substrates 101 and 102 may include a display region Da having the discharge cells for displaying an image, and may include a non-display region NDa, which does not display the image, extending from an edge of the display region Da. The non-display region NDa may surround the display region Da. For example, as shown in FIG. 3, the non-display region NDa may include all of the panel area to the left of the first NDa/Da boundary (“1^{st} Boundary in FIG. 3) and all of the panel area above the second NDa/Da boundary (2^{nd} Boundary in FIG. 3).

The first and second discharge electrodes 103 and 104 may be disposed in directions crossing one another, e.g., perpendicularly, on the respective substrates 101 and 102. For example, as described above, the plurality of first discharge electrodes 103 may be disposed on the first substrate 101, and the plurality of second discharge electrodes 104 may be disposed on the second substrate 102. The first and second discharge electrodes 103 and 104 may each include display portions 103a and 104a disposed in the display region Da, oblique portions 103b and 104b integral with the display portions and extending from the display portions 103a and 104a to the non-display region NDa to reduce a distance between adjacent electrodes, and terminal portions 103c and 104c integrally extending from the oblique portions 103b and 104b and electrically connected to external terminals of signal transmitting portions such as flexible printed cables.

A plurality of alignment structures 301 may be disposed on the inner surface of the first substrate 101 and/or the second substrate 102. The alignment structures 301 may serve to align the partitioning green sheet 105 with the corresponding first substrate 101 and/or second substrate 102. In an implementation, the alignment structures 301 may also establish a predetermined separation between the first substrate 101 and the second substrate 102, and may contact both the first and second substrates 101 and 102. In an implementation, the alignment structures 301 may be formed on both the first substrate 101 and second substrate 102, and the opposing alignment 301 structures may be aligned to one other or formed in different positions.

Each of the alignment structures 301 may be located in the non-display region NDa. In an implementation, alignment structures 301 in corners of the PDP 100 may be positioned with one side adjacent to a boundary of the display region Da and the non-display region NDa. The corner-positioned alignment structures 301 may extend away from the boundary into the non-display region NDa. The alignment structures 301 may thus assist in aligning the partitioning green sheet 105 with the corresponding first or second substrate 101 or 102, while being positioned in the non-display area NDa to avoid obscuring images generated by the PDP 100. In an implementation, the alignment structures 301 may be only in the non-display area NDa, and may not extend into the display area Da.

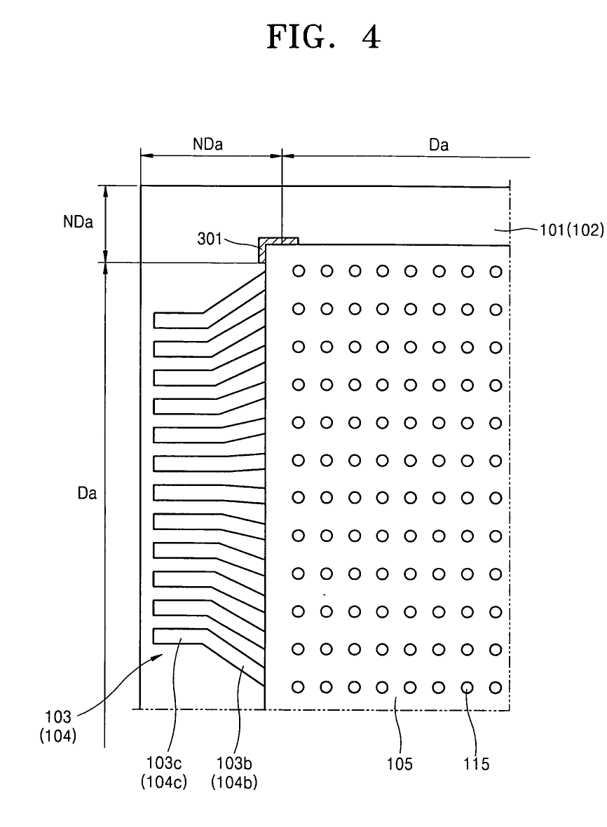

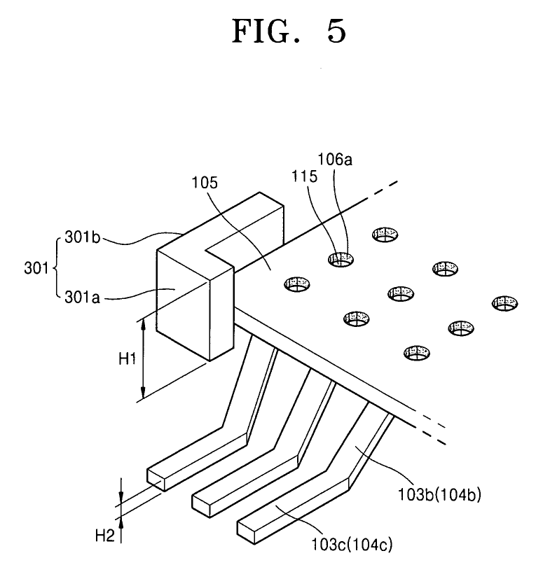

FIG. 4 illustrates a plan view of the alignment structures 301 and the partitioning green sheet 105 in the X-Y plane of FIG. 3, and FIG. 5 illustrates an enlarged perspective view of an alignment structure 301 and the partitioning green sheet 105 shown in FIG. 4. As for the description accompanying FIG. 3, parenthetical references indicate features in an embodiment wherein the alignment structures 301 are on the second substrate 102.

Referring to FIGS. 4 and 5, the partitioning green sheet 105 may be installed on a top surface of the first discharge electrodes 103 (second discharge electrodes 104). In order to easily align the partitioning green sheet 105 with the first substrate 101 (second substrate 102), the alignment structures 301 may be installed in the non-display region NDa and outside the display region Da, e.g., from the boundary of the display region Da with the non-display region NDa into the non-display region NDa, and may be located according to the outer size of the partitioning green sheet 105. One or more alignment structures 301 may be formed at any positions on the first substrate 101 (second substrate 102), and the alignment structures 301 may contact and support the partitioning green sheet 105 at corners, shorter sides, and/or longer sides thereof.

In an implementation, the alignment structures 301 may be disposed to surround four corners of the partitioning green sheet 105. Referring to FIG. 5, each of the alignment structures 301 may include a first member 301a disposed along a shorter side of the first substrate 101 (second substrate 102), and a second member 301b integrally connected to the first member 301a and extending along a longer side of the first substrate 101 (second substrate 102). These alignment structures 301 may have an “L” shape or other bent shape. In other implementations (not shown), the alignment structures 301 may have various shapes such as a raised bar shape, a raised curved shape, a raised dot (cylindrical) shape, etc.

The alignment structures 301 may extend from the first substrate 101 (second substrate 102), and may have a height H₁ that is greater than a height H₂ of the first discharge electrodes 103 (second discharge electrodes 104) so as to ensure positive engagement with the partitioning green sheet 105. In an implementation, the maximum value of the height H₁ of the alignment structures 301 may be less than a distance between the first and second substrates 101 and 102. In another implementation, the height H₁ of the alignment structures 301 may be equal to the distance between the first and second substrates 101, 102, and the alignment structures 301 may thus also act as spacers for maintaining a predetermined distance between the first and second substrates 101, 102. The height H₁ of the alignment structures 301 may be, e.g., about 30 to about 100 micrometers greater than the height H₂ of the first discharge electrodes 103 (second discharge electrodes 104), although this height may be reduced if the distance between the first and second substrates 101 and 102 is to be reduced.

The alignment structures 301 may be formed by, e.g., dispensing or printing, and may be formed of an insulating material such as a ceramic material. In an implementation, the alignment structures 301 may be formed at the same time as the first or second discharge electrodes 103 or 104, the first or second dielectric layer 108 or 111, or the first or second protective layer 109 or 112 are formed.

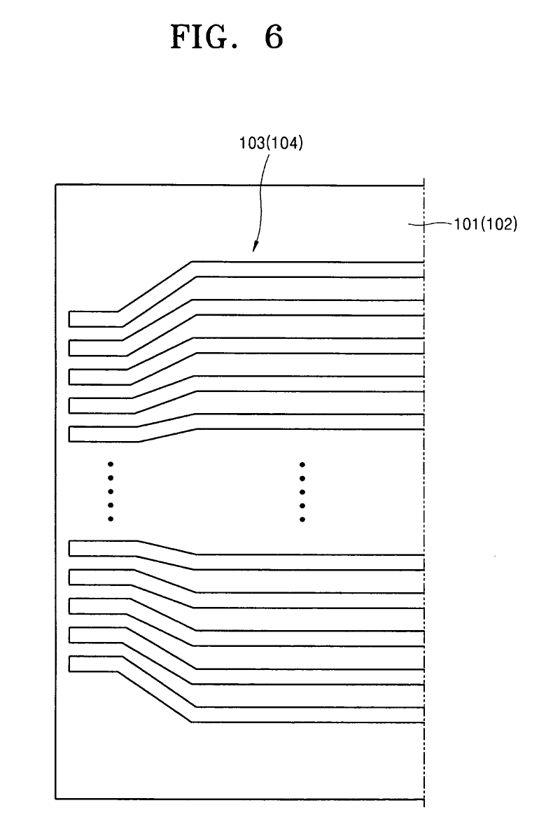

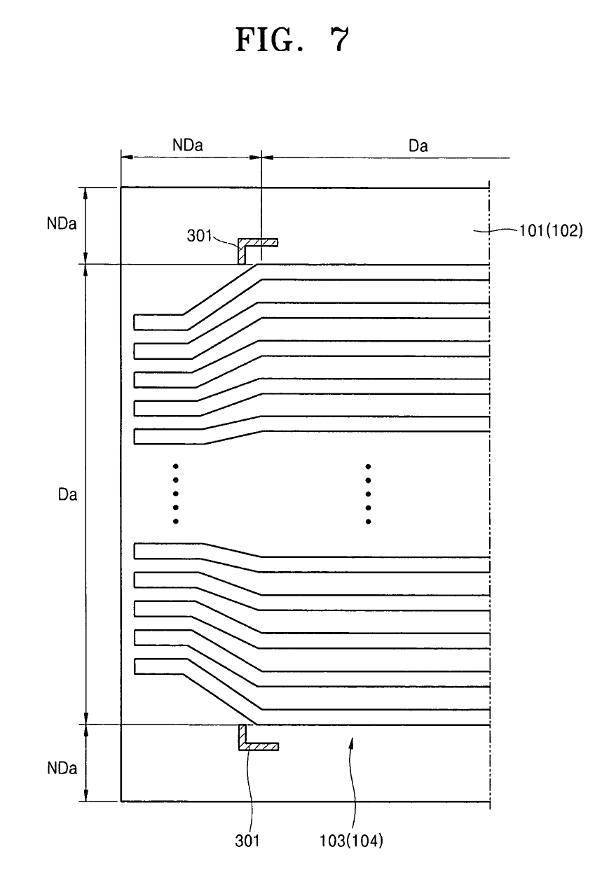

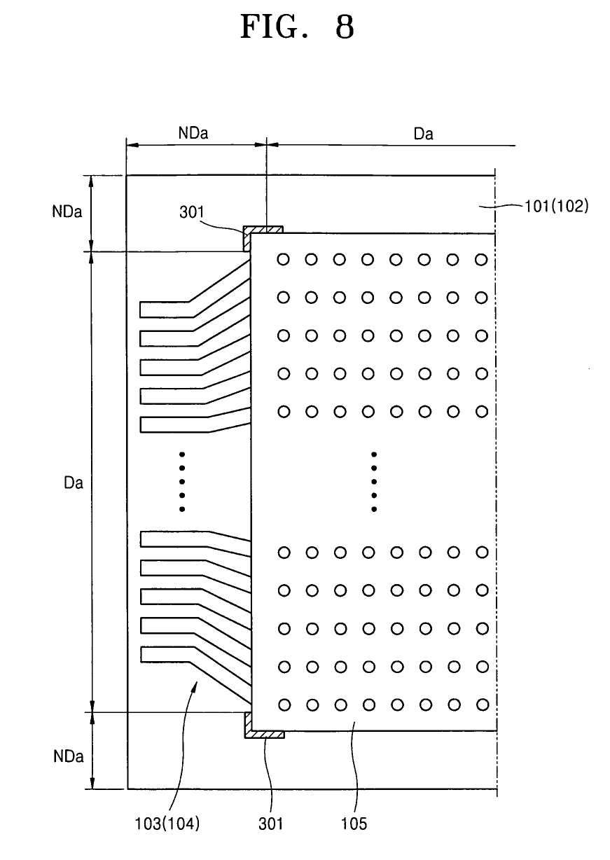

A method of manufacturing the alignment structures 301 will now be described. FIGS. 6-8 illustrate plan views in the X-Y plane of FIG. 1 showing stages in a method of fabricating a PDP according to an embodiment. In particular, FIG. 6 illustrates a plan view of the first discharge electrodes 103 (second discharge electrodes 104) patterned on the first substrate 101 (second substrate 102) of the PDP 100 of FIG. 1, FIG. 7 illustrates a plan view of alignment structures 301 formed on the first substrate 101 (second substrate 102) of FIG. 6, and FIG. 8 illustrates a plan view of the partitioning green sheet 105 contacting the alignment structures 301 of FIG. 7.

In an implementation, the second substrate 102 may be prepared and the second adhering green sheet 110 may be attached to an inner surface of the second substrate 102. A metal foil for forming second discharge electrodes 104 may be attached to a surface of the second adhering green sheet 110. The metal foil for forming second discharge electrodes may be etched and patterned into the second discharge electrodes 104, and the second discharge electrodes 104 may be fired to adhere them to the inner surface of the second substrate 102.

Referring to FIGS. 3, 5, and 7, one or more alignment structures 301 may be formed at positions ranging from a boundary of the display region Da with the non-display region NDa into the non-display region NDa of the second substrate 102. The alignment structures 301 may be formed by, e.g., patterning an insulating layer after forming respective functional layers on the second substrate 102. Preferably, the alignment structures 301 are formed at the same time as the respective functional layers are formed, in order to simplify the manufacturing process.

Referring to FIGS. 1, 2, and 8, the partitioning green sheet 105 may be prepared. The partitioning green sheet 105 may be formed of a sheet-shaped raw material. The partitioning green sheet 105 with openings dividing the discharge spaces may be separately manufactured and then attached, or may be directly formed on the second substrate 102 by printing or table coating.

Next, the partitioning green sheet 105 may be placed on the second substrate 102. The position of the partitioning green sheet 105 may be determined by contacting corners of the partitioning green sheet 105 with inner walls of the alignment structures 301. In an implementation, the third open holes 115 may then be formed in the partitioning green sheet 105, e.g., by sand blasting or etching. The third open holes 115 may be formed by etching in such a manner that the diameters of the third open holes 115 are reduced, i.e., taper, in a downward direction, i.e., the Z direction, perpendicular to the second substrate 102. Thus, the third open holes 115 in the partitioning green sheet 105 may have tapered sidewalls, such that a cross-sectional area in a plane parallel to the first and second substrates 101, 102 decreases along an axis perpendicular to a major surface of the first and second substrates 101, 102. Next, second open holes 114 communicating with the third open holes 115 are formed in the second discharge electrodes 104 by etching.

Since the second open holes 114 may be formed after the third open holes 115 are formed, the second open holes 114 may be self-aligned with the third open holes 115. In an implementation, the second open holes 114 in the second substrate may be formed prior to assembly of the partitioning green sheet 105 with the second substrate 102. In an implementation, the third open holes 115 may be formed in the partitioning green sheet 105 prior to assembly of the partitioning green sheet 105 with the second substrate 102.

Etching the second open holes 114 may expose surfaces of the second discharge electrodes 104. The exposed surfaces of the second discharge electrodes 104 may subsequently be anodized to form a second dielectric layer 111 of a metal oxide, the metal oxide including a metal of the second discharge electrodes 104. The second protective layer 112 may then formed on a surface of the second dielectric layer 111, e.g., using electrophoresis.

Next, a raw material for forming phosphor layers 106 may be coated, e.g., by printing or spraying, through the second open holes 114 communicating with the third open holes 115. First phosphor layers 106a may be formed on inner circumferential walls of the partitioning green sheet 105 in the third open holes 115, and second phosphor layers 106b may be formed on portions of the inner surface of the second substrate 102 exposed by the second open holes 114. The first phosphor layers 106a and the second phosphor layers 106b together may form the phosphor layers 106. The manufacturing method described above may be modified according to the method of forming the first discharge electrodes 103 or the second discharge electrodes 104, the method of forming the partitioning green sheet 105, or the method of coating the phosphor layers 106.

As described above, the PDP having the alignment structure, and the method of fabricating the same, may afford a number of advantages. For example, by contacting the partitioning green sheet with the alignment structures on the substrate, the partitioning green sheet may be easily aligned at a desired position, and by providing the alignment structures with a height greater than that of the discharge electrodes, positive positioning of the partitioning green sheet may be ensured. Additionally, the alignment structures may have a height such that they act as spacers between the substrates. Further, the partitioning green sheet may be disposed on the substrate through a separate process, such that manufacture of the PDP may be simplified, and the discharge electrodes may be anodized to easily form a dielectric layer.

Exemplary embodiments of the present invention have been disclosed herein, and although specific terms are employed, they are used and are to be interpreted in a generic and descriptive sense only and not for purpose of limitation. Thus, embodiments may be applied to other displays such as a field emission display, e.g., in which an anode electrode is on the second substrate, a cathode electrode is on the first substrate, and a gate electrode is therebetween. Accordingly, it will be understood by those of ordinary skill in the art that various changes in form and details may be made without departing from the spirit and scope of the present invention as set forth in the following claims.

What is claimed is:

1. A display panel, comprising:
a first substrate and a second substrate, the first and second substrates having inner surfaces facing each other;
a plurality of electrodes disposed between the first substrate and the second substrate;
a partitioning green sheet disposed between the first substrate and the second substrate; and
a plurality of alignment structures on an inner surface of at least one of the first and second substrates, the alignment structures providing an alignment reference for aligning the partitioning green sheet with the inner surface, wherein at least one of the alignment structures contacts an edge of the partitioning green sheet.

2. The display panel as claimed in claim 1, wherein the alignment structures contact corners, shorter sides, and/or longer sides of the partitioning green sheet.

3. The display panel as claimed in claim 1, wherein:
each of the first substrate and the second substrate includes a display region displaying an image and a non-display region outside the display region, and
the alignment structures are formed in the non-display region.

4. The display panel as claimed in claim 1, wherein:
the alignment structures project from the inner surface, and
the alignment structures have a height greater than that of the electrodes.

5. The display panel as claimed in claim 4, wherein:
the alignment structures have a height equal to a distance between the first substrate and the second substrate, and
the alignment structures contact the first substrate and the second substrate.

6. The display panel as-claimed in claim 4, wherein the alignment structures have a maximum height less than a distance between the first substrate and the second substrate.

7. The display panel as claimed in claim 1, wherein the alignment structures include an insulating material.

8. The display panel as claimed in claim 7, wherein:
the electrodes include first electrodes disposed in a first direction on the inner surface of the first substrate and second electrodes disposed in a second direction crossing the first direction on the inner surface of the second substrate, and
the partitioning green sheet is disposed between the first electrodes and the second electrodes.

9. The display panel as claimed in claim 7, wherein the electrodes include a metal foil.

10. The display panel as claimed in claim 9, wherein:
a dielectric layer covers a surface of the metal foil, and
the dielectric layer includes an oxide of a metal included in the metal foil.

11. The display panel as claimed in claim 10, wherein a protective layer is on a surface of the dielectric layer.

12. The display panel as claimed in claim 11, wherein the alignment structures include a same material as one-or more of the electrodes, the dielectric layer, and the protective layer.

13. The display panel as claimed in claim 1, wherein the alignment structures have a bent shape, a bar shape, a curved shape, and/or a dot shape.

14. The display panel as claimed in claim 1, wherein:
the partitioning green sheet is disposed between a plurality of first electrodes and a plurality of second electrodes, and
the partitioning green sheet includes openings corresponding to discharge spaces.

15. The display panel as claimed in claim 14, wherein the openings in the partitioning green sheet have tapered sidewalls, such that a cross-sectional area in a plane parallel to the first and second substrates decreases along an axis perpendicular to a major surface of the first and second substrates.

16. The display panel as claimed in claim 14, wherein:
the openings in the partitioning green sheet become narrower towards the second substrate,
electrodes on the second substrate have openings corresponding to the openings in the partitioning green sheet, and
the openings in the partitioning sheet and the openings in the electrodes on the second substrate have a same size at an interface thereof.

17. The display panel as claimed in claim 14, wherein phosphor layers are on the sidewalls of the openings in the partitioning green sheet.

18. A method of manufacturing a display panel, comprising:
arranging a first substrate and a second substrate such that inner surfaces of the first and second substrates face each other;
forming a plurality of electrodes between the first substrate and the second substrate;
forming a plurality of alignment structures on an inner surface of at least one of the first and second substrates, the alignment structures providing an alignment reference for aligning a partitioning green sheet with the inner surface; and
aligning the partitioning green sheet between the first substrate and the second substrate, wherein at least one of the alignment structures contacts an edge of the partitioning green sheet.

19. The method as claimed in claim 18, wherein forming the alignment structures includes forming the alignment structures to have a height greater than that of the electrodes.

20. The method as claimed in claim 19, wherein aligning the partitioning green sheet includes positioning the partitioning green sheet so that the alignment structures contact corners, shorter sides, and/or longer sides of the partitioning green sheet.
